(19) United States
(12) Patent Application Publication
(10) Pub. No.: US 2009/0089207 A1
(43) Pub. Date: Apr. 2, 2009

(54) PREPAID BUDGET CALLING ACCOUNTS WITH OVERRUNS BILLED TO A CREDIT CARD

(75) Inventors: Gregory L. Mumford, Marion, IA (US); Jon E. Abel, Cedar Rapids, IA (US); David A. Fitzgerald, Springville, IA (US); Radhika Gunasekar, Cedar Rapids, IA (US); Anna Marie Appleby, Cedar Rapids, IA (US); John M. Leslein, Marion, IA (US)

Correspondence Address: VERIZON;PATENT MANAGEMENT GROUP, 1320 North Court House Road, 9th Floor, ARLINGTON, VA, 22201-2909, US

(73) Assignee: Verizon Business Network Services Inc., Ashburn, VA (US)

(21) Appl. No.: 11/862,695

(22) Filed: Sep. 27, 2007

(51) Int. Cl. G06Q 20/00; G06F 17/10; G06F 17/30; G06F 17/40

(52) U.S. Cl. 705/39; 705/418

(57) ABSTRACT

Prepaid services include offering a plurality of services. An account is configured to track usages of the plurality of services as well as associating a plurality of recurring balances with the account, wherein each balance is associated with a respective service of the plurality of services. It is possible to deduct an amount associated with providing a particular service for a period of time from the recurring balance associated therewith.

### BACKGROUND

Service providers may have the option to extend credit to customers for provided services with the expectation of payment at the termination of a service period. Alternatively, a service provider may require a customer to pay for services before they are provided. So-called prepaid services may allow a customer to purchase services prior to their provision and usage. Accordingly, a prepaid customer may maintain a positive monetary balance in a prepaid account held with the service provider. Alternatively, the customer may purchase units of service from the service provider for use over a period of time. In the example of a telephone network, a prepaid customer may purchase telephone services in units such as minutes.

Certain characteristics of traditional prepaid systems may be undesirable for both the system operator and the customer. For instance, prepaid accounts are typically purchased in a one-off manner by the customer. The highly competitive market for prepaid calling accounts generally results in very low customer loyalty. Accordingly, providers cannot expect significant repeat business from customers.

From a customer's perspective, prepaid calling accounts that become nearly depleted may result in an effectively useless remaining balance. If the balance would only accommodate a relatively short provision of service, a customer may be apprehensive of using the balance knowing that any provision of service might need to be prematurely halted. Accordingly, small balances may not be effectively used, and therefore may be wasted.

Prepaid calling accounts are typically associated with only a single service. Accordingly, a customer may be required to purchase and maintain separate accounts for each desired service offering. Additionally, accounts offered by a service provider may include a balance that does not necessarily match a customer's desired expenditure for a particular service. Offering accounts with inflexible balances may complicate a customer's effort to follow a predetermined budget.

### BRIEF DESCRIPTION OF THE DRAWINGS

FIG. 1 illustrates an exemplary prepaid service system for providing prepaid telecommunication services;

FIG. 2a illustrates an exemplary database table definition relating to a prepaid services account record;

FIG. 2b illustrates an exemplary database table definition relating to a prepaid balance record; and

FIG. 3 illustrates a flowchart depicting exemplary steps and decisions relating to a method for providing prepaid services.

### DETAILED DESCRIPTION OF THE PREFERRED EMBODIMENT

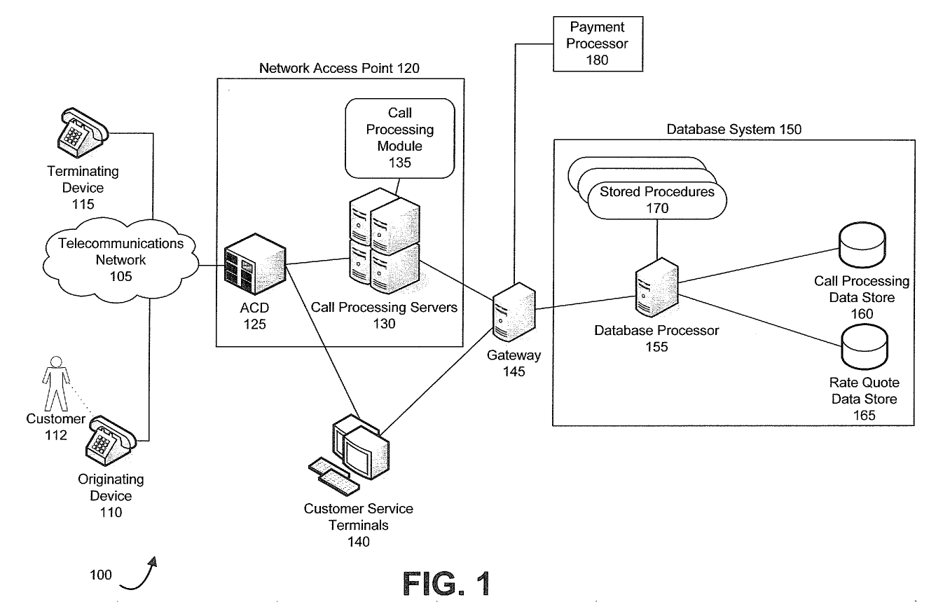

FIG. 1 illustrates one possible exemplary prepaid service system 100 for providing prepaid telecommunication services. An originating device 110 connects to a network access point 120 and a terminating device 115 through a telecommunications network 105. The network access point 120 may maintain a connection to telecommunications network 105 and may include system 100 elements such as an automated call distributor (ACD) 125 as well as a plurality of call processing servers 130. In addition to connecting to the call processing servers 130, the automated call distributor may connect to one or more customer service terminals 140. A call processing module 135 may be located on the call processing servers 130 and may include computer instructions configured to provide prepaid telecommunication services to a customer 112. A gateway server 145 may serve as an intermediary between the call processing servers 130, the customer service terminals 140, and a prepaid database system 150. The prepaid database system 150 may include a database processor 155 configured to execute a plurality of stored procedures 170. The processor 155 additionally has access to a call processing data store 160 and a rate quote data store 165.

Telecommunications network 105 may be a circuit switched network generally referred to as a public switch telephone network (PSTN). Alternatively, telecommunications network 105 may be a combination of circuit switching and packet switching network elements cooperatively connected to enable signaling system seven (SS7) based telephone calls. Other networks such as cellular networks for wireless calls and Voice Over Internet Protocol (VOIP) networks for packet switched network based voice calls may also be integrated with telecommunications network 105. Accordingly, it is to be understood that network 105 includes switches, links, gateways, etc. as necessary to facilitate the transmission of calls and data between devices 110 and 115.

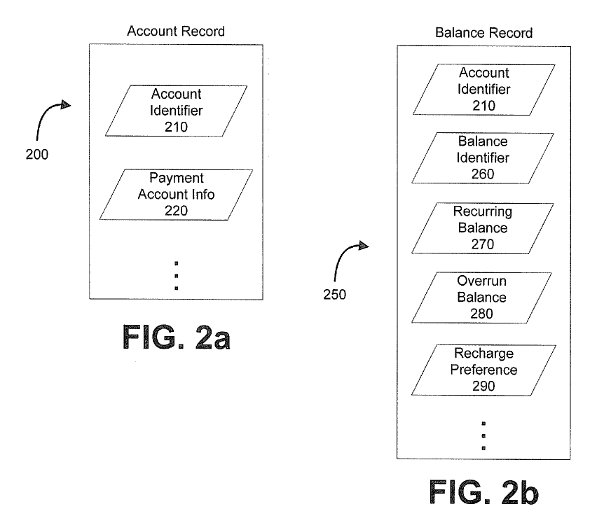

While depicted as a conventional telephone, originating device 110 may be any type of telecommunications device capable of connecting to telecommunication network 105 and communicating via one or more protocols associated therewith. Accordingly, originating device 10 may be capable of accepting input from customer 112 such as an access number for the telecommunications network access point 120, a prepaid account identifier 210 (FIG. 2a), and a telephone number associated with the terminating device 115. Similarly to originating device 110, terminating device 115 may be any type of telecommunications device capable of connecting directly or indirectly with telecommunications network 105 and receiving an incoming call therefrom. While FIG. 1 merely depicts a single originating device 110 and a single terminating device 115, it is to be understood that there may be many such devices connecting to the prepaid services system 100 at any given time. When using originating device 110 to access system 100, customer 112 may be considered a user of system 100 as well as an originating caller.

It is to be understood that FIG. I and this description thereof illustrates prepaid service in the example of prepaid telecommunications services. However, the method 300 described below, may in whole or part be applicable to other forms of prepaid services. Even in the example of prepaid telecommunications services, there may be multiple entities responsible for providing the elements of system 100. For instance, a telecommunications network provider may provide some of the components while a prepaid service provide may provide others. Additionally, terminating device 115 may not exist at all. For instance, originating device 110 may receive a prepaid service that does not include terminating device 115.

It is also to be understood that the connection between originating device 110 and terminating device 115 may be a local connection, a long distance connection, or an international connection. Each type of connection may be considered a separate type of service and may have different service rates. Prepaid service accounts may enable originating device 110 to make connections according to numerous different rates. Similarly, originating device 110 may not be connecting to terminating device 115, but may rather be receiving some other type of service from the service provider. For instance, other possible services that may be provided to customer 112 include directory assistance, data service, etc. Access to these and any other services may be provided according to respective service rates. Accordingly, prepaid system 100 may enable customer 112 to purchase prepaid accounts for each type of service that may be provided. In another exemplary approach, a single prepaid account may include separate balances for each type of service.

Network access point 120 provides a connection to telecommunications network 105 for the prepaid service provider. Network access point 120 may host telecommunications equipment for implementing a so-called intelligent network or intelligent services network. The intelligent network generally enables a telecommunications provider to offer value-added services, such as prepaid calling, to traditional telecommunication systems. Among other equipment, intelligent networks may include automated call distributor 125 and call processing servers 130. Network access point 120 may further provide local or wide area network connections for connecting prepaid services system 100 devices, e.g., automated call distributor 125, call processing servers 130, etc. While FIG. 1 only depicts a single telecommunications network access point, it is to be understood that prepaid services system 100 may have multiple such network access points 120, which may be geographically dispersed.

Automated call distributor 125 maintains a connection to telecommunications network 105 in order to receive incoming connections from originating device 110 and establish connections with terminating device 115. Automated call distributor 125 may include a telecommunications switching device such as a private branch exchange (PBX). Additionally, automated call distributor may include a processing device configured to execute call routing rules that direct an incoming call to other devices, e.g., call processing servers 130, customer service terminals 140, etc. Automated call distributor 125 may further queue incoming calls should there ever be insufficient resources available to immediately handle the calls. While FIG. 1 merely illustrates a single automated call distributor 125, other exemplary approaches may include multiple automatic call distributors 125.

Call processing servers 130 receive calls routed from automated call distributor 125 and may provide interactive functionality to customer 112. Call processing servers 130 may be automated response units, or voice response units. Such units may provide customer 112 with an audible menu of options. Customer 112 may select an option by entering a number on the key pad of their device 110 corresponding to a particular menu option. Call processing servers 130 may be further configured to receive customer 112 options through voice recognition software such that customer 112 may speak the menu option corresponding with their selection. Call processing servers 130 may receive from customer 112 multiple inputs in addition to any menu selections. These inputs may include a prepaid services account identifier 210 (FIG. 2a), a security pin, and a phone number of a terminating device 115.

Call processing servers 130 may control automated call distributor 125 through signaling communication in order to establish a connection through telecommunications network 105 to terminating device 115. Similarly, call processing servers 130 may provide signaling instructions to automated call distributor 125 in order to end, or tear down, the connection between originating device 110 and terminating device 115. Call processing servers 130 may periodically monitor the connection between originating device 110 and terminating device 115 in order to track the duration of time in which the connection is maintained, and may further conference into the connection in order to provide automated messages to the customer 112, e.g., messages indicating an impending depletion of an account balance 270, 280 (FIG. 2b).

Additionally, call processing servers 130 may include a computer readable medium encoded with computer executable instructions configured to effectuate account tracking and call processing features of the prepaid services system 100. Such computer instructions may be included in a call processing module 135. Call processing module 135 may conceptually divide a call spanning a service period into one or more lengths of time such that each length of time may represent a service increment. Service increments may be a standard increment or a custom increment. The length of time associated with a standard increment is generally equal to all other standard increments associated with a call. However, the length of time associated with a custom increment may vary from that of other custom increments as well as from that of standard increments. The length of time associated with a standard increment may be established on a system-wide, account-by-account, or product-by-product basis. Dividing the service period into one or more service increments may allow system 100 to determine whether account balances 270, 280 (FIG. 2b) are sufficient prior to providing service for an additional service increment. Additionally, call processing module 135 may be configured to provide service to customer 112 for a custom increment rather than a standard increment if account balance 220 is insufficient to provide service for the length of time associated with a standard increment. As will be discussed below, account balances 270, 280 do not necessarily store a monetary value. Rather, account balances 270, 280 may store a unit of service balance. A more detailed description of the exemplary operations that may be provided by call processing module 135 is provided below.

A gateway 145 may act as an intermediary between telecommunications network access point 120, customer service terminals 140, and prepaid database system 150. Gateway 145 may include network connections to database system 150, call processing servers 130, and customer service terminals 140. In one exemplary approach, the network connections to gateway 145 may be established on a private local area network or wide area network that can more closely guarantee the quality of service in order to minimize latency and thereby provide real-time or near real-time access and updates to data held in data stores 160 and 165. Gateway 145 may receive all requests for access to prepaid database system 150 in order to provide a barrier to direct access to database system 150. Limiting access to database system 150 may be appropriate in some circumstances. For instance, exemplary approaches may provide, queuing, improved security, access to legacy systems, etc. It is to be understood that some database processors 155 may be capable of handling a large number of requests from the call processing servers 130 and customer service terminals 140 and therefore may eliminate the need for gateway 145.

Gateway 145 may be a web application server, although any computing device having a computer readable medium including instructions for communicating with database system 150 would suffice. Gateway 145 may be a networked computer system configured with server software for accepting connections from the call processing servers 130 and customer service terminals 140. Call processing servers 130, for instance, use these connections to execute remote procedure calls on gateway 145. The remote procedure calls executed on gateway 145 communicate with database processor 150 to retrieve and set data on database system 150 through the stored procedures 170 (discussed below). While FIG. 1 merely depicts a single gateway 145, it is to be understood that gateway 145 may include a pool of gateways 145 configured to share the responsibility of interacting with database system 150.

Payment processor 180 may receive payment requests from gateway 145 and further may provide acknowledgement that a payment request was accepted. Such a payment processor 180 may be external to system 100 and may be entirely external to the telecommunications service provider that offers system 100. Payment processor 180 accepts payment account information 220 as well as a payment amount and determines whether the provided account can accept the payment amount. The payment account may be a credit card account, and payment processor 180 may be a credit card processor.

Database system 150 may be a relational database management system. Many such systems, including SQL Server, Oracle, and MySQL, among others, are generally available. Call processing data store 160 may store call processing data in row and column table format, and may include multiple tables. A row, or record, includes one or more columns, or fields, holding data values for specifically defined fields. Rows may be uniquely identified by the values of one or more columns. Indexes of one or more columns can be included to aide in searching for particular rows of the table. Other database systems, e.g., embedded databases, hierarchical systems, file based storage, etc., could be used as database system 150. Database processor 155 includes instructions on a computer readable medium that facilitate database transactions. Such instructions may be provided by one or more stored procedures 170. Additionally, processor 155 may include instructions for the bulk or mass loading of data, e.g. card activations from retail purchases. Similarly, bulk exporting of data may be needed to support accounting and revenue reporting features.

FIG. 1 depicts rate quote data store 165 as being part of database system 150. However, rate quote data store 165 may have uses outside of the context of system 100. Accordingly, it is to be understood that rate quote data store 165 may be external to system 100, such that gateway 145 may access data thereon. In an exemplary approach that excludes gateway 145, rate quote data store 165 may be accessible by call processing servers 130.

Incoming calls to automated call distributor 125 may be routed to customer service terminals 140 in order to provide personalized customer service to customer 112. Customer service terminals 140 may include a computing device and a display. A graphical user interface (GUI), or the like, provided by the terminals 140 may enable customer service personnel to access the prepaid database system 150 through the gateway 145. Accordingly, the customer service terminals 140 may provide access to stored procedures 170 of database system 150. As discussed above, stored procedures 170 may manipulate the data associated with an account record 200.

FIG. 2a illustrates an exemplary account record 200 for use with system 100. Account record 200 may be stored in call processing data store 160 of database system 150. An account identifier field 210 provides a unique identifier to differentiate accounts from one another. Payment account information that may be necessary to effectuate an automatic recharge may be stored in payment account info field 220. It is to be understood that account record 200 may have any number of additional fields. For instance, fields identifying customer 112 may be included.

FIG. 2b illustrates an exemplary account balance record 250 for use with system 100. One or more account balance records 250 may be associated with account record 200 by including account identifier 210 in account balance record 250. Balance record 250 may be uniquely identifiable with a value stored in a balance identifier field 260. Moreover, an account balance record 250 may exist for each type of service offered through system 100. Balance record 250 may include both a recurring balance 270 and an overrun balance 280. The value stored in balance fields 270, 280 may be a monetary value. However, in other exemplary approaches the value may be the number of units of service that were purchased, e.g., minutes. Each balance record 250 may track the recurring and overrun balances 270, 280 for a respective service. A rate associated with the service may further be stored in the balance record 200 or may be provided by rate quote data store 165. Recurring balance 270 may be configured to reset to a predetermined level after a period of time, e.g., a month. Moreover, rather than adding an amount to the recurring balance 270, any remaining amount of recurring balance 270 may be lost at the end of the period. Conversely, overrun balance 280 generally does not expire or reset but may be subject to periodic fees such as maintenance fees. Balance record 250 may further include a recharge preference 290. Recharge preference 290 may include an indication of whether a recharge of the overrun balance 280 is permitted. Recharge preference 290 may further include an amount to which to recharge the overrun balance 280. In another exemplary approach, recharge preference 290 may indicate a predetermined number of units of service that are to be purchased for a predetermined cost.

Customer 112 may have a need for various types of services. A service provider may provide numerous service offerings to meet the needs of multiple customers 112. Because the service needs, both in type and quantity, of a particular customer 112 may vary from other customers 112, balance records 250 associated with respective offered services may be configured with a customer specific recurring balance 270. Additionally, the customized balance records 250 may then be associated with an account record 200 that is associated with customer 112. Accordingly, through the association of one or more balance records 250, an account record 200 may be tailored to meet the specific needs of customer 112. Moreover, having an account configured to track the use of multiple services through associated balance records 250 may eliminate the need for customer 112 to maintain numerous accounts. Such a tailored account may be configured to track the usage of all offered services, or at least a subset of the offered services. Customer 112 may further develop a services budget for each desired service. For instance, customer 112 may determine a budget that defines upper limits for specific services for each month. The customer's 112 budgeted amounts may correlate to respective recurring balances 270. Accordingly, customer 112 may develop a comprehensive service account including individualized amounts budgeted for each selected service.

As explained above, system 100 may be able to provide more than one type of service to customer 112. Accordingly, recurring balance 270 may be configured to be an upper limit of expenditure on a particular service by customer 112. However, recognizing that in some circumstances, customer 112 may desire additional amounts of a particular service, overrun balance 280 may be configured to store additional purchased amounts of the service. Accordingly, in one exemplary approach, each balance record 250 may have an associated overrun balance 280. Call processing server 130 may be farther configured to deduct an amount for provided service first from the recurring balance 270 associated with the provided service. If the recurring balance 270 is insufficient, call processing server 130 may attempt to deduct the amount from the overrun balance 280 associated with the provided service. The option to purchase additional service may be a customer 112 configurable option, and may further include an option to purchase additional service at a predetermined rate. Additional configurable options may allow customer 112 to limit the number or recharges over a certain time period, or may allow customer 112 to set an upper expenditure limit for recharges over a certain time period. Any such configurable options may be set on an account wide basis or on a balance-by-balance basis. Additionally, the amount that may be recharged may be subject to a minimum transaction amount. In another exemplary approach that tracks recurring balance 270 as a monetary value, a single overrun balance may be associated with account record 200.

Stored procedures 170 (FIG. 1) may include computer executable instructions stored in database system 150 and may provide access to data stored in data stores 160 and 165. Stored procedures 170 may provide the ability to read and set the fields of account record 200 and balance record 250. Stored procedures 170 may include a balance inquire procedure that accepts an account identifier 210 as a parameter and provides the recurring and overrun balances 270, 280 associated therewith. A deduction procedure may deduct a provided amount from a specified balance 270, 280. A balance adjustment routine may allow a specified balance 270, 280 to be restored or adjusted to a larger amount.

Prepaid telecommunication accounts represented by exemplary account record 200 may include a physical representation in the form of a plastic card, i.e., a calling card. A calling card representing an account with balances 270, 280 stored in database system 150 may be referred to as a remote memory card. Accordingly, balances 270, 280 are not stored or encoded on the card. The card merely includes the account identifier 210 which enables system 100 to determine balances 270, 280 from call processing data store 160. However a physical card is not required and often is not provided due to the ability to purchase prepaid telecommunication services over the Internet from World Wide Web based retailers.

Prior to an account being available for use by customer 112, the accounts must be created. Creation of an account may include the assignment of a unique account identifier 210 and an initial recurring balance 270. The account identifiers 210 may be created and loaded into call processing data store 160 in batches. After creation, the account identifiers 210 may be provided to retail businesses for sale. After purchase by customer 112, the retailer may notify system 100 that the account should be activated for access and use by customer 112. However, it is to be understood that retailers are not the only source of prepaid accounts. The prepaid service provider may provide accounts directly to customer 112.

Computing devices such as call processing servers 130, gateway 145, and database processor 155 may employ any of a number of computer operating systems known to those skilled in the art, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, notebook, laptop, or handheld computer, or some other computing device known to those skilled in the art.

Computing devices such as call processing servers 130, gateway 145, and database processor 155, etc., may each include instructions executable by one or more computing devices such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Database system 150 may be a relational database management system (RDBMS). An RDBMS may employ Structured Query Language (SQL) in addition to a language for creating, storing, editing, and executing stored procedures, such as the PL/SQL language mentioned above. However, it is to be understood that database system 150 may be some other kind of database such as a hierarchical database, a set of files, an application database in a proprietary format, etc. Database system 150 may include a computing device, i.e., processor 155, employing a computer operating system such as one of those mentioned above, and is accessed via a network in any one or more of a variety of manners, as is well known. Exemplary systems are possible in which at least some of data stores 160 and 165 are both combined as a single data store, or are provided on completely independent databases.

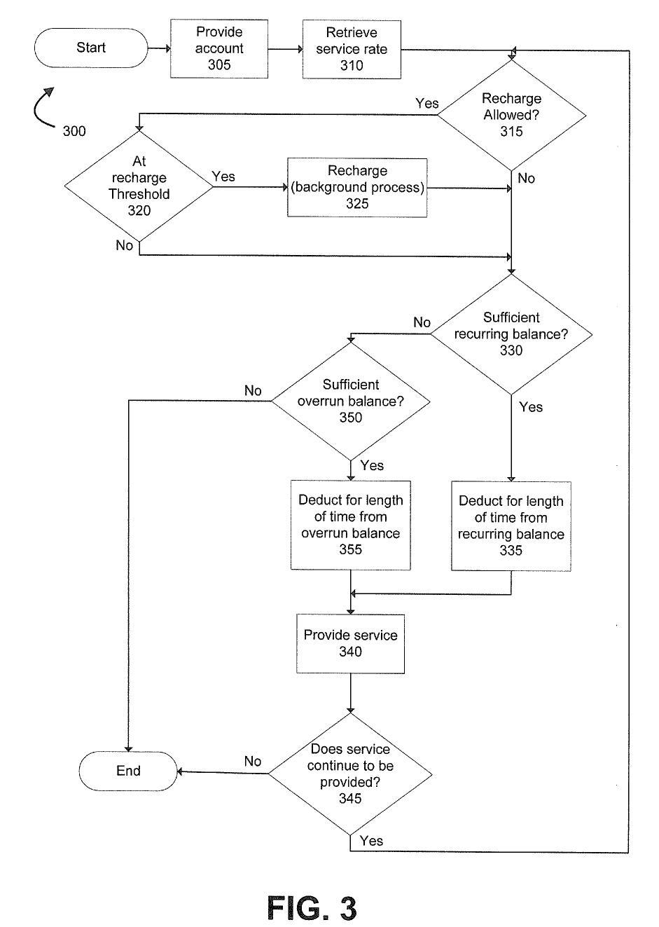

FIG. 3 illustrates a flow chart of an exemplary process 300 for providing prepaid services to customer 112 of prepaid services system 100. While process 300 is directed to the provision of prepaid telecommunications services, it is to be understood that these steps are equally applicable to other forms of prepaid services. Call processing servers 130 may include a computer-readable medium having stored instructions for carrying out certain operations described herein, including some or all of the operations described with respect to process 300. For example, some or all of such instructions may be included in call processing module 135.

Process 300 begins in step 305 in which a customer accesses a prepaid account. In one exemplary approach, customer 112 will use originating device 110 to call an access number associated with telecommunications network access point 120. Automated call distributor 125 receives the call and thereby establishes a connection to originating device 110 over telecommunications network 105. Automated call distributor 125 routes the call to call processing servers 130. Customer 112 may be presented with audible instructions for entering an account identifier 210, a security pin, and a telephone number for a terminating device 115.

Next, in step 310, call processing module 135 queries the rate quote data store 165 of the database system 150 to retrieve the service rate associated with establishing a connection to terminating device 115. A particular service may include a rate as well as other costs and fees. Some service providers may charge a fixed fee for each connection to terminating device 115. Taxes may be assessed on a per-unit of service basis. Additionally, there may be fees associated with certain types of pay-per-use phones, i.e. payphones. Accordingly, the service rate will include any costs and fees associated with providing service for a period of time and may be retrieved from the rate quote data store.

Next, in step 315, recharge preference 290 may be queried to determine whether a recharge is allowed. Recharge preference 290 may include a Boolean value indicating whether a recharge is allowed. Recharge preference 290 may further indicate an amount that may be recharged, a total number of allowable recharges in a certain time period, and a total amount that may be recharged in a given time period. Accordingly, if a recharge is allowed, the process may proceed to step 320.

Following a determination in step 315 that a recharge is allowed, it is determined in step 320 whether the account balances 270, 280 are at a recharge threshold. The recharge threshold may be fixed level based only on the balances 270, 280 amount or may be a variable level based on the balances 270, 280 amount with respect to the service rate retrieved in step 310. It is to be understood that both balances 270, 280 may be at a threshold in order to conduct a recharge because if either was above the threshold there would be no need to conduct a recharge. Moreover, initiating a recharge when balances 270, 280 reach a threshold level rather than waiting until the balances 270, 280 become depleted may allow the recharge step 325 to proceed as a background or concurrent process to the other steps of process 300.

Following a determination in step 320 that balances 270, 280 are at a recharge threshold, call processing module 135 may automatically recharge the overrun balance 280 in step 325. Call processing server 130 may initiate a recharge by querying call processing data store 160 for payment account information 220. Call processing server 130 may then send a recharge request including the retrieved payment account information 220 along with a recharge amount to gateway 145. Gateway 145 sends the payment account information 220 and recharge amount to payment processor 180. Gateway 145 may receive a response indicating whether payment processor 180 accepted the payment account information 220 and recharge request. Upon receiving an acknowledgement that the recharge was accepted, gateway 145 may call a stored procedure 170 in order to update overrun balance 280 with the amount of the recharge. In another exemplary approach where the overrun balance 280 tracks units of service rather than a monetary value, the overrun balance 280 may be updated with the predetermined number of units of service that were purchased for a predetermined cost according to recharge preference 290.

Next, in step 330, it is determined whether there is a sufficient recurring balance 270 associated with the requested service. As discussed above, system 100 divides a service provided to customer 112 over a service period into one or more service increments that may correspond to lengths of time. Service increments may include standard increments or custom increments. System 100 may set the length of time corresponding to a standard increment on a system-wide, account-by-account, or service-by-service basis. In one exemplary approach, the recurring balance 270 may need to be greater than an amount associated with the provision of service for a standard increment. Accordingly, the amount may be calculated by multiplying the length of time associated with the standard increment with the service rate. In another exemplary approach, call processing module 135 may be able to provide service for a custom increment that is less than the standard increment. In such an approach, recurring balance 270 that is too low for the provision of service for the standard increment may still be effectively depleted by providing service for a custom increment. The length of time associated with a custom increment may be determined based on the service rate (determined in step 310) and the account balance 220. Similarly, in such an exemplary approach, the amount may be the remaining recurring balance 270. If there is a sufficient recurring balance 270, the process proceeds to step 335.

Next, in step 335, an amount associated with the length of time of the service increment is deducted from the recurring balance 270. Accordingly, call processing module 135 instructs gateway 145 to call a deduction stored procedure 170 with parameters identifying the balance record 250 and providing the amount to deduct from the recurring balance 270.

Next, in step 340, service may be provided to customer 112 for up to a length of time corresponding to the length of the service increment. Call processing server 130 may cause automated call distributor 125 to establish a telecommunications connection between originating device 110 and terminating device 115. Call processing module 135 may record transaction details in a call record (not shown). Transaction details may include the number of the originating device 110, the number of the terminating device 115, the account identifier 210, the rate, and the time that service was initiated. Later, at the conclusion of the service period, the time that service was concluded may be included in the transaction details. The transaction details may allow for the reporting of information about the call to an accounting system (not shown). As discussed above, system 100 may be divided among multiple cooperating entities. For instance, a telecommunications service provider may be responsible for providing service by establishing and maintaining the connections between originating device 110 and terminating device 115. The prepaid service provider may be external to the telecommunications service provider and may merely monitor the service provided to customer 112 in order to track and maintain account balances 270, 280.

Next, in step 345, call processing module 135 determines whether service continues to be provided to customer 112. Call processing servers 130 may continuously monitor the connection between originating device 110 and terminating device 115. When the connection is ended, the transaction details may be updated to reflect the ending time of the call. If service continues to be provided, the method returns to step 315.

Following a determination that there is an insufficient recurring balance 270 in step 330, it may be determined in step 350 whether there is a sufficient overrun balance 280 associated with the requested service. As discussed above, an account balance record 250 may include both recurring balance 270 and overrun balance 280. Overrun balance 280 may be available for draw downs when the recurring balance 270 becomes depleted. As in step 330, in one exemplary approach, the overrun balance 280 may need to be greater than an amount associated with the provision of service for a standard increment. Accordingly, the amount may be calculated by multiplying the length of time associated with the standard increment with the service rate. In another exemplary approach, call processing module 135 may be able to provide service for a custom increment that is less than the standard increment. In such an exemplary approach, the amount may be the remaining overrun balance 280. If there is an insufficient overrun balance 280, the process may end thereby concluding any service that may be ongoing. If there is a sufficient overrun balance 280, the process proceeds to step 355.

Next, in step 355, an amount associated with the length of time is deducted from the overrun balance 280. Accordingly, call processing module 135 instructs gateway 145 to call a deduction stored procedure 170 with parameters identifying the balance record 250 and providing the amount to deduct from the overrun balance 280.

Following a determination that service does not continue to be provided in step 345 or a determination that there is an insufficient overrun balance 280 in step 350, the process ends.

Accordingly, system 100 and process 300 enable originating device 110 to connect to terminating device 115 with the connection fees and costs being billed to a prepaid account. Specifically, the prepaid account may include a recurring balance 270 and an overrun balance 280 associated with each service offered by system 100. A call processing module 135 may be configured to first draw down recurring balance 270 such that overrun balance 280 is not drawn upon until recurring balance 270 becomes depleted. Additionally, recurring balance 270 generally resets to a predetermined level on a periodic basis while overrun balance remains constant until it is drawn upon by call processing module 135. Call processing module 135 may be further configured to recharge overrun balance 280 through the use of payment account information 220 and payment processor 180.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain systems, and should in no way be construed so as to limit the claimed invention.

Accordingly, it is to be understood that the above description is intended to be illustrative and not restrictive. Many systems and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future systems. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites explicitly to the contrary.

What is claimed is:

1. A method, comprising:
maintaining an account configured to track usages of at least a subset of a plurality of offered services;
associating a plurality of recurring balances with the account, wherein each balance is associated with a respective service of the at least a subset of the plurality of offered services; and
deducting an amount associated with providing a particular service for a period of time from the recurring balance associated therewith.

2. The method of claim 1, further comprising restoring the plurality of recurring balances to one or more respective predetermined levels on a periodic basis.

3. The method of claim 1, further comprising associating an overrun balance with each recurring balance.

4. The method of claim 1, further comprising associating at least one overrun balance with the account.

5. The method of claim 4, wherein the deducting includes subtracting the amount from the overrun balance when the recurring balance is less than the amount.

6. The method of claim 4, further comprising selectively recharging the overrun balance.

7. The method of claim 6, wherein the recharging includes purchasing a predetermined number of units of service for a predetermined cost.

8. A system, comprising:
an account configured to track the usage of a plurality of telecommunication services, the plurality of telecommunication services including at least a subset of a plurality of offered services;
a plurality of recurring balances associated with the account, each recurring balance associated with a respective service of the plurality of telecommunication services;
a call processing server configured to deduct an amount associated with providing a particular service of the plurality of telecommunication services for a period of time from the recurring balance associated therewith.

9. The system of claim 8, wherein the account is further configured to restore the plurality of recurring balances to one or more respective predetermined levels on a periodic basis.

10. The system of claim 8, further comprising an overrun balance associated with each recurring balance.

11. The system of claim 8, further comprising at least one overrun balance associated with the account.

12. The system of claim 11, wherein the call processing server is further configured to deduct the amount from the overrun balance when the recurring balance associated with the particular service is less than the amount.

13. The system of claim 11, wherein the call processing server is further configured to selectively recharge the overrun balance.

14. The system of claim 13, wherein the call processing server is further configured to purchase a predetermined number of units of the particular service for a predetermined cost.

15. A method, comprising:
maintaining an account configured to track the usage of a plurality of prepaid telecommunication services, the plurality of prepaid telecommunication services including at least a subset of a plurality of offered services;
associating a plurality of recurring balances with the account, wherein each balance is associated with a respective service of the plurality of prepaid telecommunication services;
monitoring the provision of a particular service of the plurality of prepaid telecommunication services to an originating caller; and
deducting an amount associated with the providing step from a particular recurring balance associated with the particular service.

16. The method of claim 15, further comprising restoring the plurality of recurring balances to one or more respective predetermined levels on a periodic basis.

17. The method of claim 15, further comprising associating a plurality of overrun balances with the account, wherein each overrun balance is associated with a respective recurring balance.

18. The method of claim 17, wherein deducting includes subtracting the amount from a particular overrun balance associated with the particular recurring balance when the particular recurring balance is less than the amount.

19. The method of claim 17, further comprising recharging a particular overrun balance associated with the particular recurring balance.

20. The method of claim 19, wherein recharging includes purchasing a predetermined number of units of the particular service for a predetermined cost.
